(19) United States
(12) Patent Application Publication
(10) Pub. No.: US 2010/0101386 A1
(43) Pub. Date: Apr. 29, 2010

(54) Variable signature length web cutting apparatus

(75) Inventors: Barry Mark Jackson, York, ME (US); Dieter Theodor Ebert, Stratham, NH (US); Joseph Adrian St. Ours, Lee, NH (US)

Correspondence Address: Davidson, Davidson & Kappel, LLC, 485 7th Avenue, 14th Floor, New York, NY, 10018, US

(73) Assignee: Goss International Americas, Inc., Durham, NH (US)

(21) Appl. No.: 12/290,298

(22) Filed: Oct. 29, 2008

(51) Int. Cl. B23D 25/02; B23D 25/00; B23D 25/12

(52) U.S. Cl. 83/37; 83/287; 83/346

(57) ABSTRACT

A variable cutoff web cutting apparatus is provided including a first knife cylinder having a first segmented knife blade. The first knife cylinder rotates about a first cylinder axis in a web travel direction and the first segmented knife blade rotates about a first knife axis in the opposite direction. Also included is a first counterpart cylinder, which the first segmented knife blade contacts to perforate a web. The cutting apparatus also includes a second knife cylinder having a second knife blade. The second knife cylinder rotates about a second cylinder axis in the web travel direction and the second knife blade rotates about a second knife axis the opposite direction. Also included is a second counterpart cylinder, which the second knife blade contacts to cut the web adjacent to where the first segmented knife blade perforated the web, so as to sever the web and create a signature.

The present invention relates generally to printing presses, and more particularly to web printing presses with web-conversion machines.

### BACKGROUND OF THE INVENTION

U.S. Pat. No. 5,692,440 discloses a cutting device used to accomplish the transverse cutting of running webs into products of variable lengths and is usable particularly in a folding apparatus that is situated downstream of a rotary printing press. The cutting device has a cutting cylinder support that carries two diametrically opposed cutting cylinders which rotate with, as well as with respect to, the cutting cylinder support. Each cutting cylinder carries a plurality of cutting blades with these blades being engageable with cutting strips located on the surface of a counter cutting and collection cylinder. The cutting cylinder support is rotatable at a first speed and the cutting cylinders supported by it are rotatable at a second speed.

U.S. Pat. No. 7,338,425 discloses a variable length cutting device includes a cutting cylinder and a transfer cylinder. The transfer cylinder cooperates with the cutting cylinder for cutting a ribbon into signatures having a desired cutoff length. An adjustable diameter portion of the transfer cylinder can be moved in a direction toward and away from the central axis of the transfer cylinder for adjusting the desired cutoff length of the signatures.

### SUMMARY OF THE INVENTION

A variable cutoff web cutting apparatus is provided including a first knife cylinder having a first segmented knife blade. The first knife cylinder rotates about a first cylinder axis in a direction corresponding to a web travel direction and the first segmented knife blade rotates about a first knife axis in a direction opposite the web travel direction. The cutting apparatus also includes a first counterpart cylinder and the first segmented knife blade contacts the first counterpart cylinder to perforate a web. The cutting apparatus also includes a second knife cylinder having a second knife blade. The second knife cylinder rotates about a second cylinder axis in the direction corresponding to the web travel direction and the second knife blade rotates about a second knife axis in the direction opposite the web travel direction. The cutting apparatus also includes a second counterpart cylinder and the second knife blade contacts the second counterpart cylinder and cuts the web adjacent to where the first segmented knife blade perforated the web, so as to sever the web and create a signature.

A knife cylinder is also provided including a cylinder body rotating about a cylinder axis and a knife shaft rotating about a knife axis. The knife shaft is rotably connected to the cylinder body. The knife cylinder also includes a knife blade rotably connected to the knife shaft and a rocker arm connecting the knife shaft to the cylinder body such that a radial distance between the cylinder axis and the knife axis may be adjusted by adjusting the position of the rocker arm.

A method of varying a length of signatures using a web cutting apparatus is also provided. The method includes the steps of rotating a knife blade about an axis of a knife cylinder body in one direction; rotating the knife blade about an axis of a knife shaft in a second direction; and adjusting a first distance between the axis of the knife cylinder body and the axis of the knife shaft and adjusting a second distance between the axis of the knife shaft and a tip of the knife blade. The knife blade cuts a web and creates signatures.

### BRIEF DESCRIPTION OF THE DRAWINGS

The present invention is described below by reference to the following drawings, in which:

FIG. 1 schematically shows an axial view of a web being converted into signatures by a signature creation device according to an embodiment of the present invention;

FIG. 2 schematically shows an enlarged schematic axial view of one of the knife cylinder pairs shown in FIG. 1 according to an embodiment of the present invention;

FIG. 3 shows a highly schematic cross-sectional view of the knife cylinder shown in FIG. 2 according to an embodiment of the present invention;

FIG. 4 schematically shows an enlarged view of the knife blade cutting the web according to the embodiment of the present invention shown in FIGS. 1 to 3; and

FIG. 5 shows a table including predicted results for the knife cylinder pair of the embodiment shown in FIGS. 2 to 4 for various signatures lengths.

### DETAILED DESCRIPTION

In the web offset printing process, a continuous web of paper is transported through a printing press. Near the beginning of the press, one or more printing units apply ink to the web to repeatedly create a pattern, or impression, of text and images. At the end of the press, a web conversion machine, such as a folder, is typically used to cut and fold the web into signatures.

There are many known ways to convert a web into signatures. The web is commonly slit into ribbons, which can be stacked on top of each other and then former folded. Some folders, such as pinless former folders, cut the ribbons or web and deliver one or more streams of signatures. Other folders, such as combination folders, commonly introduce additional folds, such as half-folds and quarter-folds. The ribbons or web are typically cut with a knife cylinder having a knife blade.

Signature length is the distance between successive cuts. Signature length may be varied by changing the knife cylinder diameter, or by accelerating and decelerating the knife cylinder between cut events. To avoid damage to the signature during cutting, it is desirable to match the velocity of the knife blade with the velocity of the web or ribbons being cut.

Signatures may be created in web offset printing presses when a rotating knife, mounted on a knife cylinder, engages a rotating anvil, mounted on an opposing anvil cylinder, and cuts a web, or alternatively ribbons. The knife cylinder and anvil cylinder may be directly geared to each other and therefore are phase locked. In such instances, the knife cylinder is sized so that a diameter of the knife cylinder matches a diameter of a print cylinder, which prints images on the web, and the rotational frequency of the knife cylinder is equal to the print unit rotational frequency. A knife tip, or a point that pierces the web to create signatures, extends outside a theoretical pitch diameter of the knife cylinder. The knife tip sweeps an arc through the web, through some angle. The knife is fixed to the knife cylinder and therefore can travel at a velocity that is greater than the velocity of the web. During cutting, there often is a short interval of time when there is a slight velocity differential between the knife tip and the web. A urethane body running parallel to the knife and extending about an inch on both sides of the knife may be employed to pinch the web help minimize an affect of the velocity differential. The pinch is localized, yet wide enough to tension the web about the knife tip and enable a clean cut. Some velocity differential, or knife tip gain, may be preferred, but excessive knife tip gain is not.

Successive cutting cylinder pairs may employed, with first and second cylinder pairs performing a portion of each cut. The second cutting cylinder pair may be over sped in order to accommodate a small range of product length variation. After the second cutting cylinder pair makes a cut the resulting signature is accelerated to move the signature away from the rotating knife so the knife tip does not damage a tail edge of the signature. A velocity-matched knife tip may be employed to cut the web because velocity differentials between the knife tip and the web can damage the product. A first partial cut, completed by the first cutting cylinder pair, only perforates the web, so an over sped knife will elongate the perforation in a direction of the web travel.

Creating signatures of a different length can require changing the rotational frequency of the cutting cylinder pairs relative to the rotational frequency of the associated printing cylinder, which can cause a velocity mismatch between the knife tip and the web. A velocity mismatch can cause tearing of the signature, instead of a clean cut. To prevent such tearing, the knife tip may be driven so that the velocity of the knife tip in the direction of the web travel equals the web velocity or have some minor gain above a nominal web velocity. Drive motors can be fashioned to alter the rotational velocity within a single cycle to vary the position of the knife. The cutting cylinder pair can be accelerated so that the cutting cylinder pair is in a proper position to cut the web, then decelerated back to match the web velocity at a moment when the knife engages the associated anvil. This method of accelerating and decelerating may be limited, however; because the amount of torque required to accelerate and decelerate the knife and anvil cylinders can increase beyond the capability of the drive motors, beyond a certain rotational velocity.

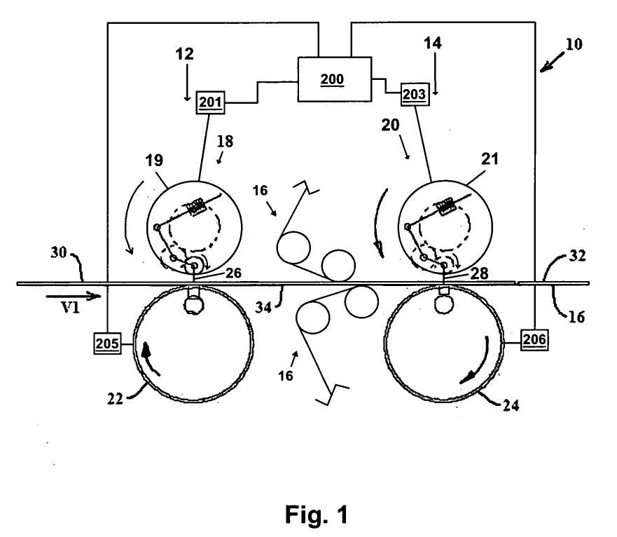

FIG. 1 shows a schematic axial view of a web cutting apparatus 10 according to an embodiment of the present invention, having two knife cylinder pairs 12, 14 and transport tapes 16. Knife cylinder pairs 12, 14 include knife cylinders 18, 20 and counterpart cylinders 22, 24. Knife cylinders 18, 20 include cylinder bodies 19, 21 and segmented knife blades 26, 28.

Knife blades 26, 28 convert a web 30 into signatures 32. While web 30 travels past knife cylinder 18 at a velocity V3, knife blade 26 partially cuts web 30 in a cross-web direction. The partial cut may be a series of slits, for example. Web 30 then approaches cylinders 20, 24 and knife blade 28 cuts web 30 at positions where knife blade 26 did not cut web 30, in a manner finishing the cut started by cylinder pair 12, creating signatures 32. Cylinders 22, 24 may be geared together and thus phase locked. Transport tapes 16 may be provided between cylinder pairs 12, 14 to prevent snap back caused by a cutting event.

Motors 201, 203 may rotate cylinder bodies 19, 21 counterclockwise, respectively, which in a preferred embodiment may, via gearing, rotate knife blades 26, 28 clockwise, respectively. Motors 205, 206 may rotate counterpart cylinders 22, 24 clockwise, respectively. Motors 201, 203, 205, 206 may be controlled by a controller 200.

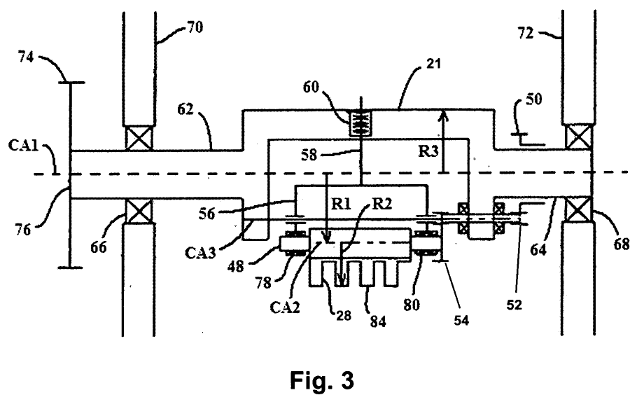

Web cutting apparatus 10 may create signatures having different cut lengths by rotating cylinder bodies 19, 21 at various rotational frequencies for different signature lengths, while maintaining a constant velocity of knife tip 84 (FIG. 3) that substantially equals the velocity of web 30 when knife blades 26, 28 cut web 30.

In an alternative embodiment a single cylinder pair cuts web 30 into signatures 32, operating in a manner similar to each cylinder pair 12, 14, but equipped with a knife blade having a continuous trim edge.

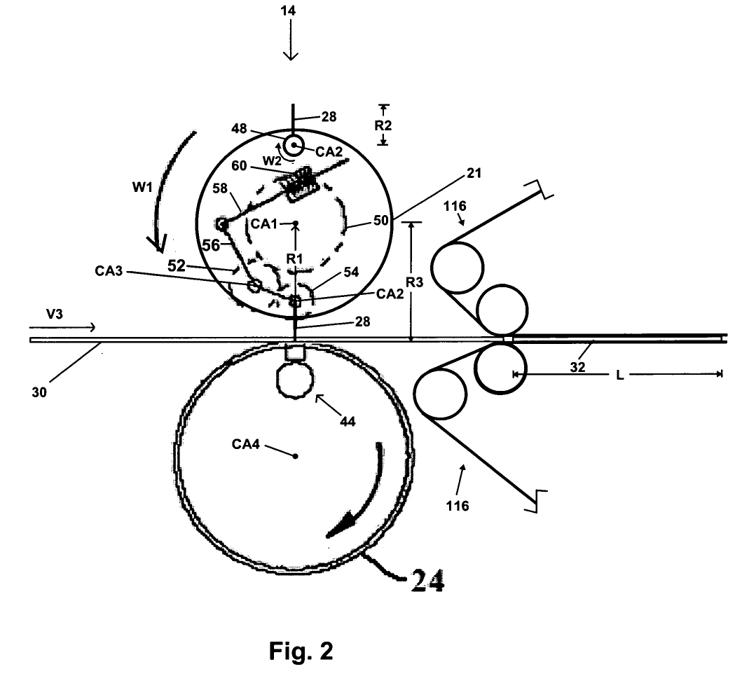

FIG. 2 shows an enlarged schematic axial view of knife cylinder pair 14 according to the embodiment of the present invention shown in FIG. 1. Knife cylinder 20 includes a knife blade 28, a cylinder body 21, a knife shaft 48, gears 50, 52, 54, a rocker arm 56, a screw rod 58, and a screw thread 60. Cylinder body 21 is centered about a center axis CA1. A gear 50 is also mounted about center axis CA1. Knife blade 28 is non-rotatably attached to knife shaft 48, which is centered about, and rotates about, a center axis CA2. Knife shaft 48 is attached to cylinder body 21 such that knife blade 28 rotates about a center axis CA1 as cylinder body 21, along with center axes CA2, CA3, is rotated about center axis CA1. Thus, knife blade 28 simultaneously rotates about center axes CA1, CA2. Knife shaft 48 and cylinder body 21 rotate in opposite directions. Knife shaft is rotated in a direction such that when knife blade 28 cuts web 30 knife blade 28 is traveling in the opposite direction as web 30.

Gears 50, 52, 54 may be are centered about center axes CA1, CA2, and CA3, respectively. In this embodiment, gear 52 is a compound gear. Rocker arm 56 is connected to knife shaft 48 on one end and screw rod 58 on the other end and includes a pivot point at compound gear 52. A radial position of knife shaft 48, and thus a radial distance R1 between center axes CA1, CA2, may be adjusted by pivoting a section of rocker arm 56 between center axes CA3, CA2, about center axis CA3 using screw rod 58. This may be accomplished by rocker arm 56 swinging knife shaft 48 about compound gear 52. Screw thread 60 is fixed to cylinder body 21 and supports screw rod 58, such that screw rod 58 may be translated within screw thread 60.

In a preferred embodiment, gear 50 is stationary and compound gear 52 is rotated about gear 50 via rotation of cylinder body 21. As compound gear 52 rotates, compound gear 52 rotates gear 54, which is coupled to knife shaft 48. The gearing ratios between gears 50, 52, 54 may be fixed so that knife blade 28 is properly phased and is traveling at the desired velocity as knife 28 contacts web 30. Gear 50 may be provided with a phasing mechanism for initial set-up to correct the phasing of knife blade 29 with respect to web 30 to accommodate signature length adjustments. In an alternative embodiment, cylinder body 21 and knife blade 28 may each be rotated by a separate motor.

Knife blade 28 is oriented on knife shaft 48 so that knife blade 28 extends radially away from center axis CA1 when center axis CA2 is located below CA1. As knife shaft 48 rotates about center axis CA2, a tip 84 of knife blade 28 travels a cycloidal path, relative to a stationary reference. As knife blade 28 cuts web 30, knife blade 28 is preferably a straight line that is perpendicular to web 30.

For clarity, knife blade 28 is shown directly above and below center axis CA1 in FIG. 2. Knife blade 28 is shown above center axis CA1 mounted on knife shaft 48, but without associated gears 50, 52, 54. Knife blade 28 is shown below center axis CA1 without knife shaft 48, but schematically positioned in relation to associated gears 50, 52, 54. As knife blade 28 and knife shaft 48 are directly above center axis CA1, rotating tip 84 of knife blade 28 may reach a peak of rotation where tip 84 is a furthest distance from web 30. As knife blade 28 and knife shaft 48 are directly below center axis CA1, a tip 84 of knife blade 28 engages anvil 44 to cut web 30. In this embodiment, each revolution of knife blade 28 about center axis CA1 creates one cut.

Counterpart cylinder 24 rotates about a center axis CA4 with a surface velocity V2 equal to a web velocity V3. In a preferred embodiment, counterpart cylinder 24 can include a rotating anvil 44, which provides a backstop for knife blade 28 as knife blade 28 cuts web 30. Anvil 44 rotates about CA4 as knife blade 28 rotates about center axis CA1. Anvil 44 can be configured and geared in relation to cylinder 24 as knife blade 46 is configured and geared in relation to cylinder 20. Anvil 44 can be eccentrically mounted on a rotating anvil shaft and rotated about the rotating shaft to change a radial distance of anvil 44, in relation to CA4, to match radial distance R1. Accelerator tapes 16 may grips signatures 32 as signatures 32 are formed. In another embodiment, accelerator tapes may be present between knife cylinder pairs 12, 14 to prevent snap back which may be caused by a break in web 30 or by a cutting event.

In another embodiment counterpart cylinder 24 can include a continuous blanket of high density urethane to provide a continuous cutting rubber for knife blade 28. The continuous blanket may be a changeable blanket sleeve that is replaced with a blanket sleeve having a different circumference with each change in signature length. When changeable blanket sleeve are employed center axis CA4 may be translated to accept sleeves of different circumferences.

Cylinder pair 12 (FIG. 1), in cutting web 30 (FIG. 1), operates in substantially the same manner as cylinder pair 14. Cylinder pair 12 also includes substantially the same components as cylinder pair 14.

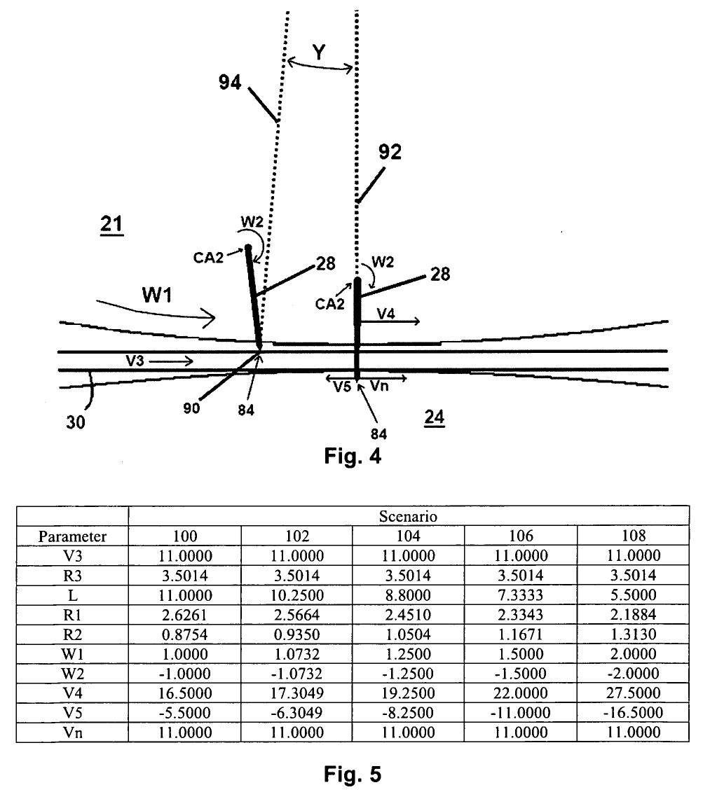

In FIGS. 2 and 3, central axis CA2 maintains a radial distance R1 from central axis CA1. Knife blade 28 extends a radial distance R2 from center axis CA2. Radial distances R1, R2 may be adjusted so that radial distance R3 between knife tip 84 (FIG. 4) and center axis CA1 as knife blade 28 cuts web 30 is set as desired.

In one embodiment, counterpart cylinder 24 is covered with a high density urethane to provide a continuous cutting rubber. A drawback to such a design is that knife blade 28 may engage counterpart cylinder 24 at a different circumferential location with each revolution of counterpart cylinder 24. Alternately, counterpart cylinder 24 could have a changeable outer sleeve, and a new sleeve could be installed whenever signature length L is changed so that knife blade 28 engages the sleeve at the same location with each sleeve revolution.

A preferred embodiment has a counterpart cylinder 24 designed like knife cylinder 20 with a cutting rubber in place of knife blade 28, and the cutting rubber being engaged by knife blade 28 with each knife cylinder 20 revolution. The cutting rubber could be mounted eccentrically to facilitate changing the cutting rubber height.

FIG. 3 schematically shows a cross-sectional view of knife cylinder 20 shown in FIG. 2 according to an embodiment of the present invention. Knife cylinder 20 has journals 62, 64 supported by bearings 66, 68 attached to side frames 70, 72. A drive gear 74 is attached to an axial end 76 of journal 62. Knife shaft 48 is supported by bearings 78, 80 attached to rocker arm 56.

Knife blade 28 is essentially driven by two independent drive inputs. During operation of knife cylinder 20, a motor connected to drive gear 74 rotates knife cylinder 20 about center axis CA1 at an angular velocity W1. As knife cylinder 20 rotates, center axis CA2 of knife shaft 48 rotates along with knife cylinder 20 about center axis CA1 at angular velocity W1. At the same time, gears 50, 52, 54 are driven so that knife shaft 48 rotates about CA2 at an angular velocity W2, where W2=−W1. Knife shaft 48 thus rotates in a direction opposite the rotational direction of knife cylinder 20, and in this embodiment knife shaft 48 performs one full revolution about center axis CA2 for each revolution of cylinder body 21 about center axis CA1.

Because knife blade 28 is being rotated in two opposite directions simultaneously, the net velocity of knife blade 46 in the direction that web 30 is traveling substantially equals the velocity of web 30, as knife blade 46 cuts web 30. Thus, knife blade 28 must be rotated fast enough about center axis CA2 to compensate for a velocity component opposite the direction web 30 is traveling, which is a product of rotation of knife blade 28 about center axis CA1, as knife blade 28 cuts web 30.

A length of signatures 32 is controlled by angular velocity W1 of knife cylinder 20. For a given web velocity V3, signature length L is increased by reducing angular velocity W1 and decreased by increasing angular velocity W1. Unlike conventional methods, adjusting signature length L advantageously does not require changing angular velocity W1 between cuts by accelerating and decelerating cylinder body 21 or changing knife cylinder pitch radius R3. Signature length L is infinitely variable within the operating window of knife cylinder 20.

Knife shaft 48 runs at an angular velocity W2 about center axis CA2 at radial distance R2 necessary for the velocity of knife blade 28 to equal the velocity of web 30. Angular velocity W2 and radial distance R2 are also adjusted so knife blade 28 is in a proper position to cut web 30 as knife shaft 48 approaches nip 100.

A tangential velocity, in relation to web 30, at which knife blade 28 cuts web 30 is dependent upon radial distance R1, radial distance R2, angular velocity W1 or angular velocity W2. For a set pitch radial distance R3, radial distance R1 is varied in proportion to radial distance R2 to achieve a desired tangential velocity of knife blade 28 at which knife blade 28 cuts web 30. Radial distance R2 may be varied by adjusting a length of knife blade 28, replacing knife blade 28 with a blade of a different length or adjusting how knife blade 28 is attached to knife shaft 48. As angular velocity W1 is adjusted to change a cutoff length of signatures produced by web cutting apparatus 10, angular velocity W2 is varied accordingly so that knife blade 28 is in proper position to cut web 30. Thus, radial distance R1, radial distance R2, angular velocity W1 and angular velocity W2 may be adjusted to satisfied desired tangential velocity and cutoff length values.

FIG. 4 shows an enlarged schematic view of knife blade 28 cutting web 30 according to the embodiment of the present invention shown in FIGS. 2 and 3. Knife blade 28 is shown in two positions for illustrative purposes. Knife blade 28 is shown with tip 84 along a line 94 as knife blade 28 first contacts web 30 and along a line 92 as knife blade 28 is at the bottom of the guillotine motion by which knife blade 28 cuts web 30. As tip 84 of knife blade 28 first contacts web 30, knife blade 28 is being rotated clockwise about central axis CA2 at angular velocity W2 and knife blade 28 is also being rotated counterclockwise about central axis CA1 (FIG. 2) at angular velocity W1. Thus, as knife blade 28 contacts web 30, knife blade 28 is being forced in opposite directions, tangent to web 30, simultaneously.

When knife blade 28 is in the position along line 92, at the bottom of the guillotine cutting motion, knife blade 28 is still being rotated about central axes CA1, CA2 at angular velocities W1, W2, respectively. Along line 92, tip 84 of knife blade 28 has a tangential velocity V4, in a direction opposite of web 30 travel, due to rotation of knife blade 28 about central axis CA1 and a tangential velocity V5, in the direction of web 30 travel, due to rotation of cylinder body 21 about central axis CA2. Because velocity V4 is greater than velocity V5, tip 84 is traveling at a net velocity Vn in the direction of web 30 travel (Vn=V4−V5).

By adjusting radial distance R1 with rocker arm 56 (FIG. 2), tangential net velocity Vn may be set equal to web velocity V3. Tangential net velocity Vn may also advantageously be slightly higher or lower than web velocity V3 to optimize the cut event. As knife blade 28 cuts web 30, a motion of knife tip 84 is preferably normal to web 30 so that knife blade 28 cuts web 30 like a guillotine, producing a higher quality cut.

While radial distance R1 is adjusted to achieve the desired tangential net velocity Vn, radial distance R2 may also be adjusted so that the sum of radial distances R1 and R2 exceeds pitch radius R3 by a desired amount. In one embodiment, knife blade 28 is eccentrically mounted on knife shaft 48 for adjustment of radial distance R2.

The guillotine motion of knife blade 28 reduces an angle Y of contact, in related to center axis CA1 (FIG. 2), between knife blade 28 and web 30. Knife blade 28 first contacts web 30 at a location 90. Line 94 intersects location 90 and center axis CA1 (FIG. 2). Angle Y is an angle between line 94 and line 92, which intersects center axes CA1, CA4 (FIG. 2). Compared to conventional knife cylinder designs, the guillotine motion of the present invention may reduce angle Y by approximately a factor of three or four. The reduction in angle Y achieved by the present invention may advantageously improve cut quality and reduce a torque required to create the cuts. Additionally, because the radial position of knife blade 28, in relation to center axis CA1, is variable, a gain of knife tip 84, relation to the a velocity of web 30, may be greater than, equal, or less than the velocity of web 30, to optimize the cutting of web 30.

FIG. 5 shows a table including predicted results for knife cylinder pair 14 of the embodiment shown in FIGS. 1 to 4, under scenarios 100, 102, 104, 106, 108, where pitch radius R3 is 3.5014 inches and web velocity V3 is 11 in/sec. Knife shaft 48 (FIG. 3) performs one full revolution about center axis CA2 as cylinder body 21 (FIG. 2) performs one full revolution about center axis CA1 and therefore, angular velocity W1 of cylinder body 21 about center axis CA1 equals the angular velocity W2 of knife shaft 48 about center axis CA2, in an opposite direction.

Each scenario 100, 102, 104, 106, 108 has a different desired signature length L. For a constant web velocity V3, to decrease signature length L, angular velocity W1 of cylinder body 21 about center axis CA1 is increased. As angular velocity W1 of cylinder body 21 about center axis CA1 is increased, angular velocity W2 of knife shaft 48 is proportionately increased. To ensure that a tangential net velocity Vn of knife blade 28, in the direction of web 30 travel, equals a velocity V3 of web 30, a radial distance R1 between center axis CA1 and center axis CA2 is decreased as angular velocity W2 is increased. The distance from center axis CA2 to knife tip 84 (FIG. 3), a radial distance R2, increases by an amount proportional to the amount radial distance R1 decreases, so that knife blade 46 is reciprocated toward web 30 in a guillotine motion a same distance even though radial distance R1 is varied. For simplicity radial distance R1 plus radial distance R2 equal radial distance R3.

As shown, to change signature length L from 11 to 5.5 inches, while maintaining a knife tangential net velocity Vn equal to web velocity V3, requires a reduction in radial distance R1 from 2.6261 inches to 2.1324 inches.

As an additional embodiment, cylinder body 21 and knife shaft 48 can be embedded into a rotating sleeve. A degree of freedom exists between the cylinder body 21 and the sleeve where the rotational frequency can be different between the two elements. Since the drum is embedded in a sleeve with a surface velocity matched to the web, there is no undue strain or change in tension to the web at the cut event.

The sleeve would have a series of rings spaced in the axial direction with openings between rings in accordance with a profile of knife blade 28. Knife blade 28 extends beyond cylinder body only through these openings as it penetrates anvil 44. The rings are constructed with urethane to eliminate snap back during the cut event. The rings may be connected at various locations that do not interfere with the rotation of knife blade 28. The sleeve has to be velocity matched to web 30 for this purpose and is only needed if tension of web 30 is sufficient to cause snap back. The sleeve would be removed in a signature creation scheme that isolated the snap back or minimized web tension.

A further embodiment incorporates two knife blades on opposite sides of knife cylinder 20. The second knife would help balance knife cylinder 20 and would advantageously reduce angular velocity W1 of cylinder body 21 about center axis CA2 by a factor of two.

As an additional embodiment, the signature creation could be generated by a single knife cylinder using a cut on cylinder approach, rather than the two knife cylinders 18 and 20 shown in FIG. 1, for example. In this embodiment the counterpart cylinder would be part of the collect cylinder.

A further embodiment is a knife cylinder pair without a fixed theoretical pitch radius. For longer signatures, the two cylinders in the knife cylinder pair can pivot about a respective gear to increase the center to center distance. The knife shaft radius relative to the cylinder body would still move, but movements would be over a smaller range. A smaller knife adjustment range would be required.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A variable cutoff web cutting apparatus comprising:
a first knife cylinder including a first segmented knife blade, the first knife cylinder rotating about a first cylinder axis in a direction corresponding to a web travel direction and the first segmented knife blade rotating about a first knife axis in a direction opposite the web travel direction;
a first counterpart cylinder, the first segmented knife blade contacting the first counterpart cylinder to perforate a web;
a second knife cylinder including a second knife blade, the second knife cylinder rotating about a second cylinder axis in the direction corresponding to the web travel direction and the second knife blade rotating about a second knife axis in the direction opposite the web travel direction; and
a second counterpart cylinder, the second knife blade contacting the second counterpart cylinder and cutting the web adjacent to where the first segmented knife blade perforated the web, so as to sever the web and create a signature.

2. The variable cutoff web cutting apparatus recited in claim 1 further comprising a first motor rotating the first knife cylinder and the first knife blade, a second motor rotating the second knife cylinder and the second knife blade and a controller controlling the first motor and the second motor.

3. The variable cutoff web cutting apparatus recited in claim 1 wherein the first counterpart cylinder includes a first rotating anvil contacting the first segmented knife blade as the first segmented knife blade perforates the web.

4. The variable cutoff web cutting apparatus recited in claim 3 wherein the second counterpart cylinder includes a second rotating anvil contacting the second segmented knife blade as the second segmented knife blade cuts the web.

5. The variable cutoff web cutting apparatus recited in claim 1 wherein the first knife cylinder performs one revolution about the first cylinder axis as the first segmented knife blade performs one revolution about the first knife axis.

6. The variable cutoff web cutting apparatus recited in claim 1 wherein the second knife cylinder performs one revolution about the second cylinder axis as the second knife blade performs one revolution about the second knife axis.

7. The variable cutoff web cutting apparatus recited in claim 1 wherein the second knife blade is segmented.

8. The variable cutoff web cutting apparatus recited in claim 1 wherein the first knife cylinder includes a first cylinder body and the second knife cylinder includes a second cylinder body, the first cylinder body rotating the first segmented knife blade about the first cylinder axis and the second cylinder body rotating the second knife blade about the second cylinder axis.

9. The variable cutoff web cutting apparatus recited in claim 8 wherein the first knife cylinder includes a first rocker arm connecting the first segmented knife blade to the cylinder body such that a radial distance between the cylinder axis and the knife axis may be adjusted by adjusting the position of the rocker arm.

10. A knife cylinder comprising:
a cylinder body rotating about a cylinder axis;
a knife shaft rotating about a knife axis, the knife shaft rotably connected to the cylinder body;
a knife blade rotably connected to the knife shaft;
a rocker arm connecting the knife shaft to the cylinder body such that a radial distance between the cylinder axis and the knife axis may be adjusted by adjusting the position of the rocker arm.

11. The knife cylinder recited in claim 10 further comprising a screw rod connecting the rocker arm to the cylinder.

12. The knife cylinder recited in claim 11 further comprising a screw thread, the screw rod translatable within the screw rod to adjust the position of the rocker arm.

13. The knife cylinder as recited in claim 10 wherein adjusting the position of the rocker arm adjusts a tangential velocity of the knife blade.

14. The knife cylinder recited in claim 10 further comprising a first gear driving the cylinder body about the cylinder axis and a second gear driving the knife shaft about the knife axis.

15. The knife cylinder recited in claim 10 further comprising a compound gear, the compound gear connected to a pivot point of the rocker arm and the radial distance between the cylinder axis and the knife axis is adjusted by swinging knife shaft about the compound gear.

16. A method of varying a length of signatures using a web cutting apparatus:
rotating a knife blade about an axis of a knife cylinder body in a first direction;
rotating the knife blade about an axis of a knife shaft in a second direction; and
adjusting a first distance between the axis of the knife cylinder body and the axis of the knife shaft and adjusting a second distance between the axis of the knife shaft and a tip of the knife blade;
wherein the knife blade cuts a web and creates signatures.

17. The method as recited in claim 16 wherein the adjusting the first distance between the axis of the knife cylinder body and the axis of the knife shaft and adjusting the second distance between the axis of the knife shaft and the tip of the knife blade varies a tangential velocity of the knife blade in relation to a web as the knife blade cuts the web.

18. The method as recited in claim 16 wherein the knife blade is coupled to a knife gear that rotates the knife blade in the first direction and the knife cylinder body is coupled to a cylinder gear that rotates the knife cylinder body in the second direction and rotating the cylinder gear rotates the knife gear.

19. The method as recited in claim 18 wherein the knife gear is coupled to a stationary gear and rotating the cylinder gear rotates the knife gear about the stationary gear.

20. The method as recited in claim 16 wherein the knife blade is rotated about the axis of the knife cylinder body in one direction at an angular velocity and the knife blade is rotated about the axis of the knife shaft in the second direction at the same angular velocity.
